(19) United States
(12) Patent Application Publication
(10) Pub. No.: US 2009/0101551 A1
(43) Pub. Date: Apr. 23, 2009

(54) Oil changing device

(76) Inventor: Ying-Chieh Liao, Taichung (TW)

Correspondence Address: Liao, Ying-Chieh, P.O. Box 44-2049, Taipei, 10668, TW

(21) Appl. No.: 11/976,097

(22) Filed: Oct. 22, 2007

(51) Int. Cl. B01D 29/88; B01D 35/143

(52) U.S. Cl. 210/94; 210/104

(57) ABSTRACT

An oil changing device includes a used oil tank connected with an air suction device which is connected with a compressor and a vacuum generating device. A switch is connected between the vacuum generating device and the compressor. A new oil tank includes a pipe connected to a mechanical item whose oil is to be changed and another pipe connected to a connector of the used oil tank. The compressor and the vacuum generating device suck air in the mechanical item so as to form a negative pressure status to suck the used oil from the mechanical item into the used oil tank. The new oil in the new oil tank is then sucked into the mechanical item via another pipe controlled by another switch.

### BACKGROUND OF THE INVENTION

(1) Field of the Invention

The present invention relates to an oil changing device which sucks the used oil from machine completely and the new oil can be supplied into the machine.

(2) Description of the Prior Art

Many types of modern machine use hydraulic oil to transfer kinetic energy and the hydraulic oil are compressed under high pressure and in contact with moving parts in the machine. The hydraulic oil is contaminated by debris of metal parts and has to be replaced with new hydraulic oil. For a hydraulic cylinder, the used hydraulic oil is sucked by a suction machine and the new hydraulic oil is pumped into the hydraulic cylinder. The inside of the hydraulic cylinder has to be kept in vacuum status or the air bubbles affect the transferring of the force and this may cause danger results. Conventional air pump introduces air into the hydraulic cylinder.

The present invention intends to provide an oil changing device which uses a compressor to suck the air in the hydraulic cylinder such that the used oil can be sucked into the used oil tank and new hydraulic oil can be easily supplied into the hydraulic cylinder.

### SUMMARY OF THE INVENTION

The present invention relates to an oil changing device that comprises a used oil tank connected with an air suction device which includes a first switch. A new oil tank includes a first oil pipe which is connected with a splitter. A second oil pipe has one end connected to the splitter and the other end of the second pipe is connected with a third oil pipe which is connected with a mechanical item whose oil is to be changed. A second switch is connected to the splitter and controls a communication of the second and third oil pipes. When the second pipe is turned to open and the second and third pipes are in communication with each other, a vacuum status is defined in the mechanical item and the used oil in the mechanical item is sucked into the used oil tank. The second switch is then operated to communicate with the first and third oil pipes, new oil in the new oil tank is sucked into the mechanical item.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the oil changing device of the present invention;

FIG. 2 is a plain view to show the oil changing device of the present invention;

FIG. 3-1 shows the cap, the valve and the used oil tank;

FIG. 3-2 is a cross sectional view to show the valve is not yet raised by the used oil in the used oil tank;

FIG. 3-3 is a cross sectional view to show the valve is raised by the used oil in the used oil tank and seals the first air pipe;

FIG. 4 shows that the used oil is sucked from the mechanical item;

FIG. 5 shows new oil is supplied into the mechanical item, and

FIG. 6 shows another embodiment of the new oil tank and the used oil tank.

### DETAILED DESCRIPTION OF THE PREFERRED EMBODIMENTS

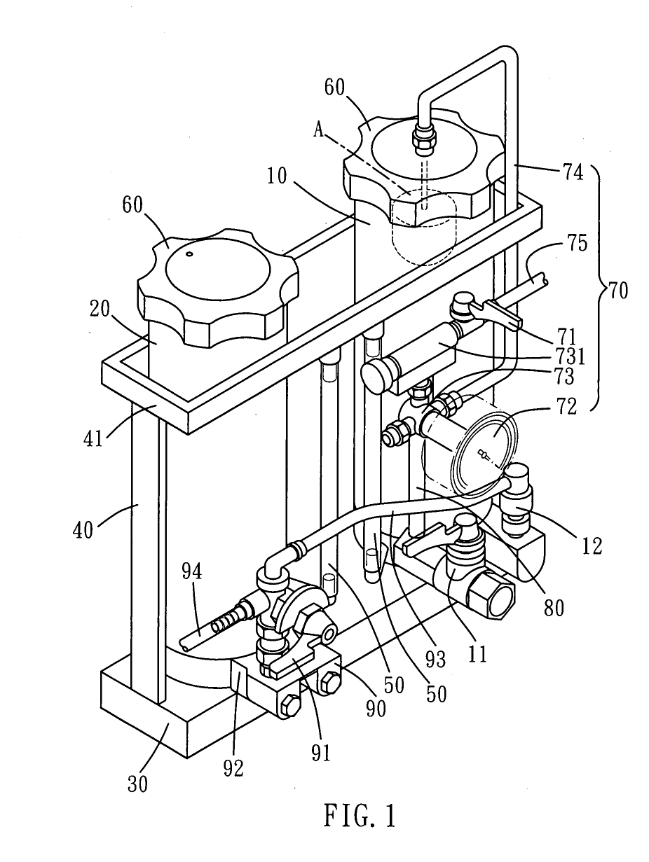

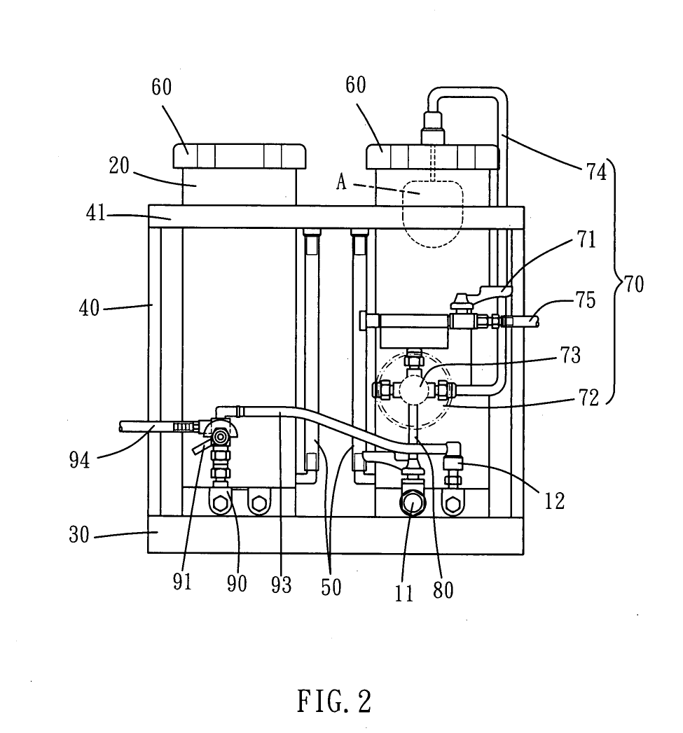

Referring to FIGS. 1 and 2, the oil changing device of the present invention comprises a used oil tank 10 connected with an air suction device 70 and a new oil tank 20. Both of the new and used oil tanks 20, are rested on a base 30 and a frame 41 is connected to the base 30 by two support posts 40 and encloses the new and used oil tanks 20, 10 to prevent unexpected impact to the two tanks 10, 20. Each of the new and used oil tanks 20, 10 has a cap 60 mounted a top thereof. A release valve 11 and a connector 12 are connected to the used oil tank 10. Each of the used oil tank 10 and the new oil tank 20 includes a transparent indication tube 50 from which the user can check the level of the oil in each of the used oil tank 10 and the new oil tank 20.

The air suction device 70 includes a first air pipe 74 which is connected between the cap 60 of the used oil tank 10 and a splitter 73. Two ends of the splitter 73 are respectively connected to a vacuum gauge 72 and a vacuum generating device 731 which is connected to a first switch 71, a second air pipe 75 is connected between the first switch 71 and a compressor (not shown). An upright post 80 is connected between the splitter 73 and the release valve 11.

The new oil tank 20 includes a first oil pipe 92 which is connected with a splitter 90. A second oil pipe 93 has one end connected to the splitter 90 and the other end of the second pipe 93 is connected with a third oil pipe 94 which is connected with a mechanical item such as a hydraulic cylinder (not shown) whose oil is to be changed. A second switch 91 is connected to the splitter 90 and controls a communication of the second and third oil pipes 93, 94.

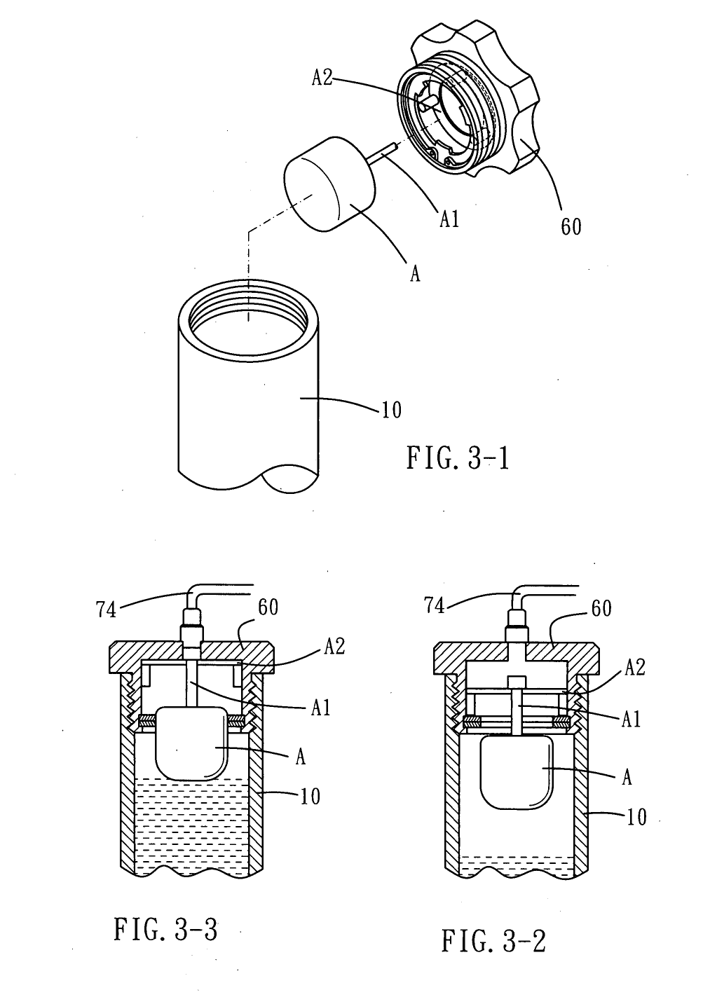

As shown in FIGS. 3-1, 3-2 and 3-3, the cap 60 of the used oil tank 10 has a valve “A” which is a hollow member and floats on the level of the used oil in the used oil tank 10. The valve “A” has a rod “A1” extending therefrom and a positioning member “A2” is connected with the rod “A1”. When the level of the used oil is low, the rod “A1” and the positioning member “A2” are at low position, and the through hole through the cap 60 on the used oil tank 10 is in communication with the first air pipe 74. When the level of the used oil is raised to move the valve “A” upward and the through hole in the cap 60 on the used oil tank 10 is sealed by the rod “A1”, the user is acknowledged to release the used oil via the release valve 11.

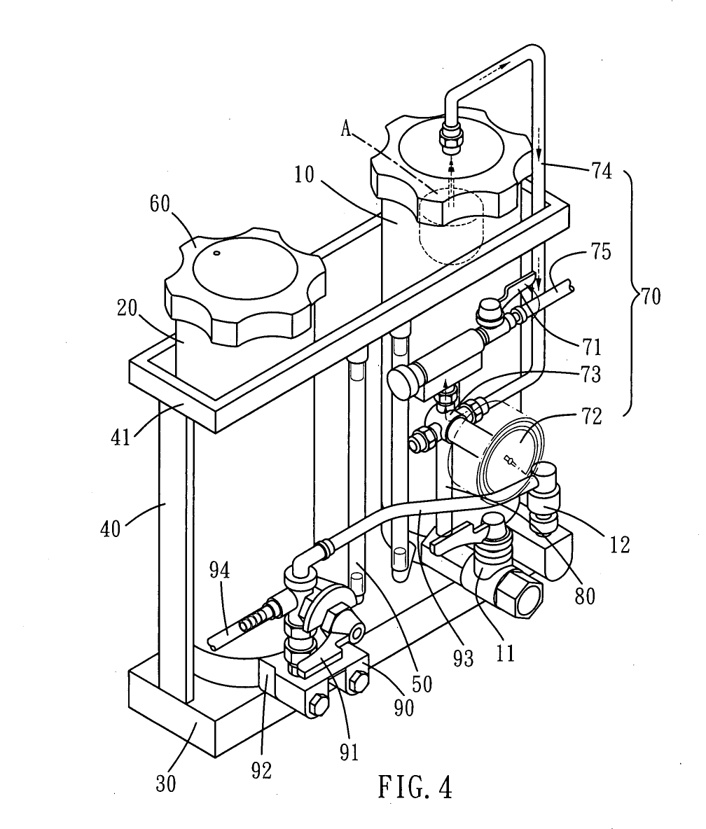

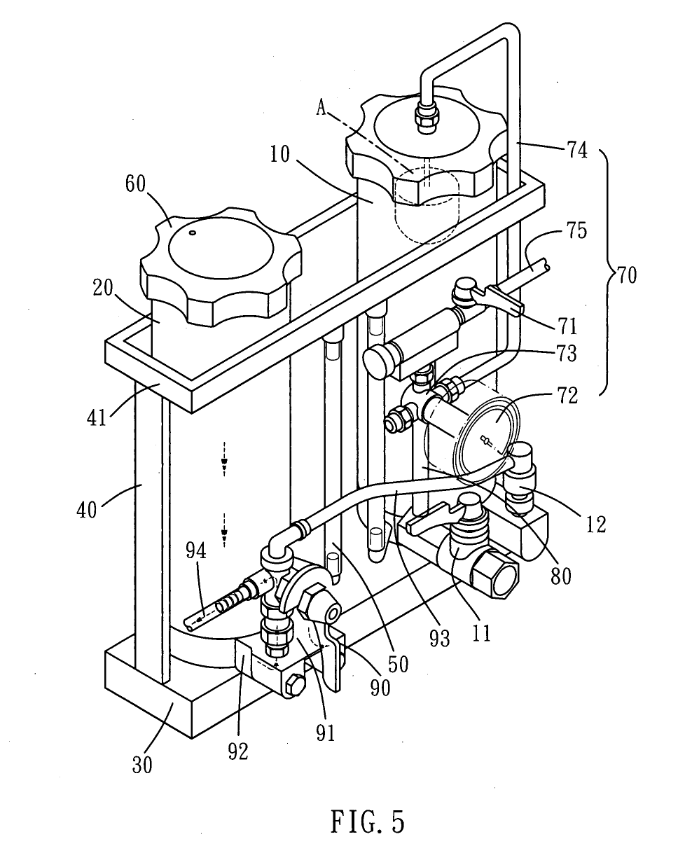

As shown in FIG. 4, when the second switch 91 is turned to open and the second and third pipes 93, 94 are in communication with each other. The compressor and the vacuum generating device 731 suck air in the mechanical item so as to form a negative pressure status to suck the used oil from the mechanical item into the used oil tank 10. As shown in FIG. 5, the second switch 91 is then operated to communicate with the first and third oil pipes 92, 94, new oil in the new oil tank 20 is sucked into the mechanical item.

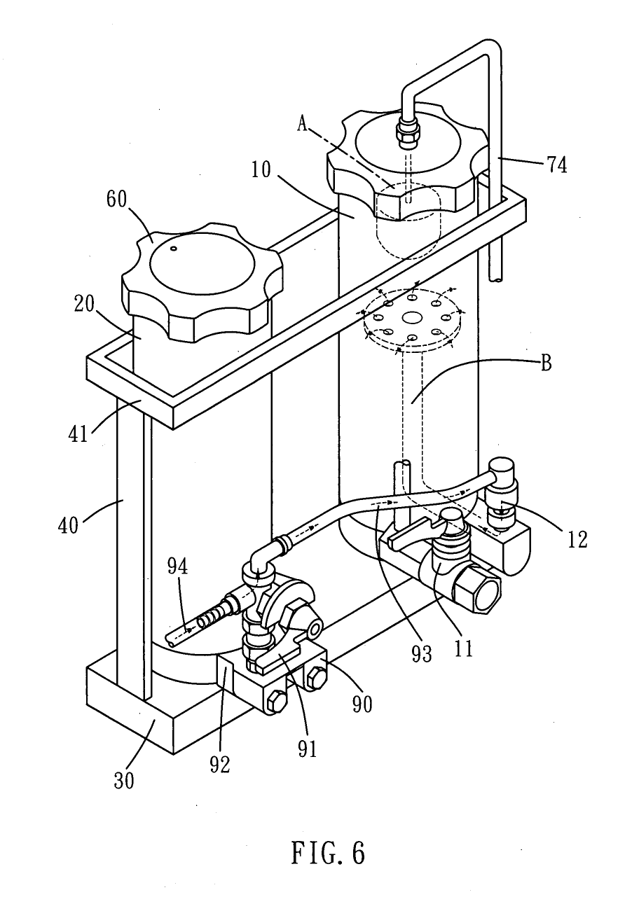

FIG. 6, shows that each of the used oil tank 10 and the new oil tank 20 is made by transparent material and the pipe “B” in the used oil tank 10 can clearly show the used oil is sucked into the used oil tank 10.

While we have shown and described the embodiment in accordance with the present invention, it should be clear to those skilled in the art that further embodiments may be made without departing from the scope of the present invention.

What is claimed is:

1. An oil changing device comprising:
a used oil tank connected with an air suction device which includes a first switch;
a new oil tank including a first oil pipe which is connected with a splitter, a second oil pipe having one end connected to the splitter and the other end of the second pipe connected with a third oil pipe which is connected with a mechanical item whose oil is to be changed, a second switch connected to the splitter and controlling a communication of the second and third oil pipes, and
when the second switch is turned to open and the second and third pipes are in communication with each other, a vacuum status is defined in the mechanical item and the used oil in the mechanical item is sucked into the used oil tank, the second switch is then operated to communicate with the first and third oil pipes, new oil in the new oil tank is sucked into the mechanical item.

2. The device as claimed in claim 1, wherein the new and used oil tanks are rested on a base.

3. The device as claimed in claim 2, wherein a frame is connected to the base by two support posts and encloses the new and used oil tanks.

4. The device as claimed in claim 1, wherein each of the new and used oil tanks has a cap mounted a top thereof.

5. The device as claimed in claim 4, wherein the cap of the used oil tank has a valve.

6. The device as claimed in claim 1, wherein the air suction device includes a first air pipe which is connected between the cap of the used oil tank and a splitter, two ends of the splitter are respectively connected to a vacuum gauge and a vacuum generating device which is connected to the first switch, a second air pipe is connected between the first switch and a compressor.

7. The device as claimed in claim 1, wherein a release valve is connected to the used oil tank.

8. The device as claimed in claim 1, wherein each of the used oil tank and the new oil tank includes a transparent indication tube.

9. The device as claimed in claim 1, wherein each of the used oil tank and the new oil tank is made by transparent material.
